(19) United States
(12) Patent Application Publication
(10) Pub. No.: US 2010/0326262 A1
(43) Pub. Date: Dec. 30, 2010

(54) Chaff Pod Dispenser

(76) Inventors: Benjamin J. Galanti, Carmel, IN (US); David J. Broadhead, Indianapolis, IN (US); Michael A. Huff, Quincy, IN (US)

Correspondence Address: BAKER BOTTS LLP, 2001 ROSS AVENUE, 6TH FLOOR, DALLAS, TX, 75201-2980, US

(21) Appl. No.: 12/267,245

(22) Filed: Nov. 7, 2008

Related U.S. Application Data
(60) Provisional application No. 60/986,436, filed on Nov. 8, 2007.

(51) Int. Cl. B64D 1/00

(52) U.S. Cl. 89/1.51

(57) ABSTRACT

According to one embodiment, a chaff pod includes at least two dispensers disposed within a chaff pod housing. Each of the dispensers has a surface defining an opening through which a number of countermeasures may be dispensed. The dispensers are configured to be coupled to the aircraft. The first dispenser directs countermeasures in a first direction, and the second dispenser directs countermeasures in a second direction. The difference between the first direction and the second direction form a relative angle.

### RELATED APPLICATIONS

This application claims priority to U.S. Provisional Patent Application Ser. No. 60/986,436, entitled “CHAFF POD DISPENSER,” which was filed on Nov. 8, 2007.

### TECHNICAL FIELD OF THE DISCLOSURE

This disclosure generally relates to chaff dispensers, and more particularly to a chaff pod dispenser that may be configured on an aircraft.

### BACKGROUND OF THE DISCLOSURE

Chaff is a radar countermeasure that includes pieces of conductive material that disrupt electro-magnetic signals. Chaff may be dispensed from an aircraft to disrupt radar signals. Reflected signals received by the radar may include ghost information, which may camouflage the aircraft's position.

### SUMMARY OF THE DISCLOSURE

According to one embodiment, a chaff pod includes at least two dispensers disposed within a chaff pod housing. Each of the dispensers has a surface defining an opening through which a number of countermeasures may be dispensed. The dispensers are configured to be coupled to the aircraft. The first dispenser directs countermeasures in a first direction, and the second dispenser directs countermeasures in a second direction. The difference between the first direction and the second direction form a relative angle.

Some embodiments of the disclosure may provide numerous technical advantages. For example, one embodiment of the chaff pod may camouflage an aircraft from enemy radar or heat seeking detection systems from the front as well as the side. The chaff pod may be mounted on the aircraft such that a first dispenser dispenses countermeasures to the side of the aircraft, while a second dispenser dispenses countermeasures toward the front of aircraft. A bracket may be used to mount the chaff pod to the aircraft using an existing bolt hole pattern suitable for mounting known chaff pod designs. Thus, protection of the aircraft may be enhanced without significant modifications to the aircraft.

Other technical advantages will be readily apparent to one of ordinary skill in the art from the following figures, descriptions, and claims. Moreover, while specific advantages have been enumerated above, various embodiments may include all, some, or none of the enumerated advantages.

### BRIEF DESCRIPTION OF THE DRAWINGS

A more complete understanding of embodiments of the disclosure will be apparent from the detailed description taken in conjunction with the accompanying drawings in which:

FIG. 1 is a perspective view of one embodiment of a chaff pod according to the teachings of the present disclosure;

FIG. 2 is a side elevational view of the chaff pod dispenser of FIG. 1 that is mounted on an aircraft;

FIG. 3 is a top view of the chaff pod dispenser of FIG. 1;

FIG. 4 is a partial view of the chaff pod dispenser of FIG. 1 shown with its central access door opened to reveal a sequencer;

FIGS. 5A and 5B are chaff pod dispensers of FIG. 1 shown with brackets that may be used for mounting to the aircraft; and

FIG. 6 is a flowchart showing one embodiment of a series of actions that may be performed to implement the chaff pod of FIG. 1.

### DETAILED DESCRIPTION OF EXAMPLE EMBODIMENTS

Countermeasure dispensers for aircraft may dispense chaff and/or flares. Dispersal of chaff or flares may camouflage the position of the aircraft from enemy radar or heat seeking detection systems, respectively.

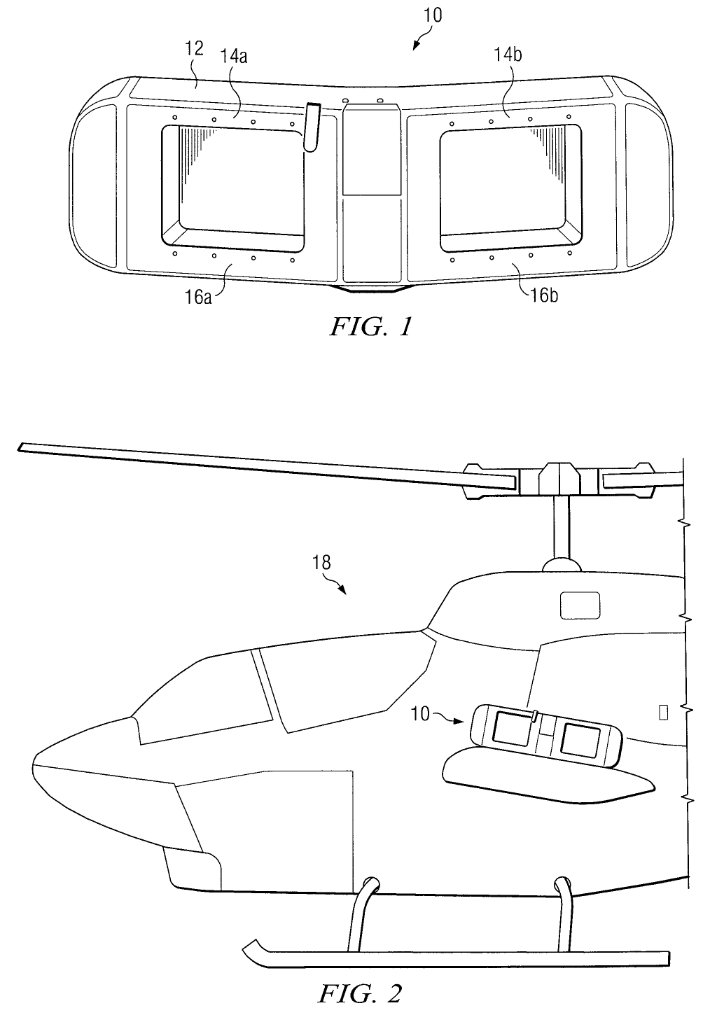

FIG. 1 shows one embodiment of a chaff pod 10. Chaff pod 10 generally includes a chaff pod housing 12 within which two dispensers 14a and 14b may be disposed. According to the teachings of the present disclosure, dispenser 14a may be oriented at an angle relative to dispenser 14b such that countermeasures may be dispensed to the side as well as toward the front of an aircraft.

Dispensers 14a and 14b may be any suitable device that are configured to hold and dispense one or more countermeasures, such as chaff or flares. Each dispenser 14a and 14b has a front surface 16a and 16b with openings through which the countermeasures are dispensed. Countermeasures stored in dispenser 14a or 14b may be ejected in a direction approximately normal to their respective front surface 16a or 16b.

Any suitable type of countermeasures may be used. In one embodiment, countermeasures may include elongated pieces of conductive strips. Conductive strips may be used to disrupt radar signals. In another embodiment, countermeasures may include at least one flare that creates heat. Flares may be used to evade heat seeking detectors, such as those commonly used in heat seeking missiles.

FIG. 2 shows one example of an aircraft 18 with which the chaff pod 10 of FIG. 1 may be used. In this particular embodiment, aircraft 18 is a military helicopter; however, the chaff pod 10 may be configured on any suitable type of aircraft, such as an airplane, or any vehicle, such as an automobile or watercraft. Although chaff pod 10 is shown coupled to the side of the aircraft 18, the chaff pod 10 may be coupled to any portion of the aircraft 18.

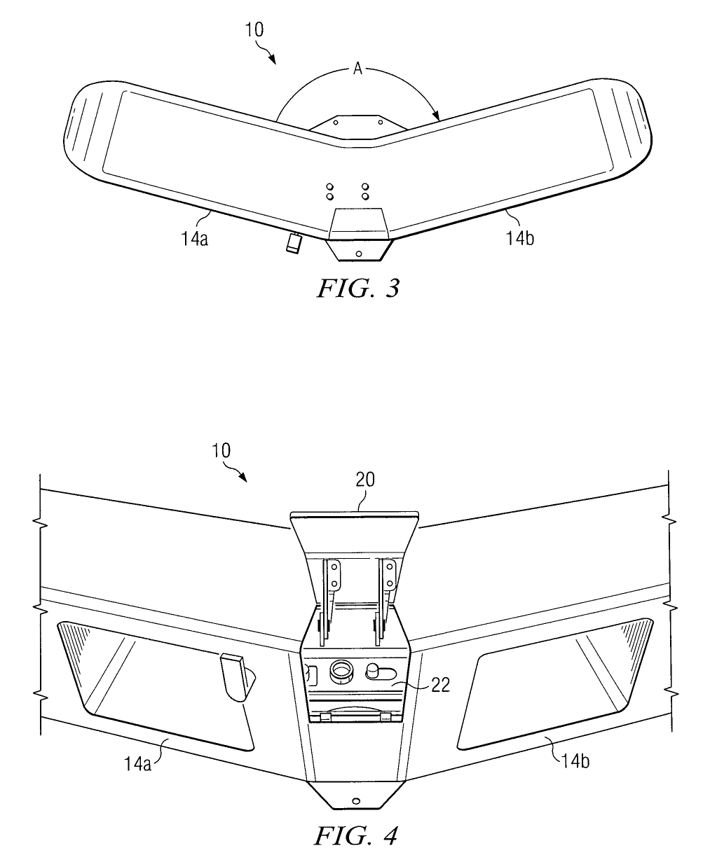

FIG. 3 is a top view of the chaff pod 10 of FIG. 1. The particular chaff pod 10 shown has a size of approximately 4.0 feet long, 1.0 feet deep, and 2.5 feet wide. Chaff pod 10, however, may have any suitable dimensions, such as 1 to 10 feet long, 0.1 to 3 feet deep, and 1 to 10 feet wide. According to the teachings of the present disclosure, the second dispenser 14b may be oriented at an angle A relative to the first dispenser 14a such that dispenser 14b may dispense countermeasures to the side of the aircraft 18, while dispenser 14b dispenses countermeasures toward the front of the aircraft 18.

According to the teachings of the present disclosure, the first dispenser 14a directs its countermeasures in a first direction and the second dispenser 14b directs countermeasures in a second direction. The difference between the first direction and the second direction form a relative angle A. In one embodiment, the angle A may be in the range of 120 to 170 degrees. In the particular embodiment shown, the angle A is 150 degrees.

Certain embodiments of the chaff pod 10 may provide coverage for the front as well as side portions of the aircraft 18.

FIG. 4 is a partial, perspective view of the chaff pod 10 of FIG. 1 shown with a central access door 20 opened in order to reveal a sequencer 22. As shown, sequencer 22 may be disposed between the dispensers 14a and 14b in the chaff pod housing 12. In other embodiments, the sequencer 22 may be disposed at any location within the housing 12, or may even be disposed outside of the housing 12. The sequencer 22 is coupled to the aircraft 18 through a cable (not specifically shown) for receiving control signals from the aircraft 18. The sequencer 22 is also coupled to the dispensers 14a and 14b using another cable (not specifically shown) that transmits activation signals to each of the countermeasures stored in dispensers 14a and 14b.

Sequencer 22 may be made from any suitable type of circuitry. In one embodiment, sequencer 22 includes a computer processor that executes instructions stored in a memory. In another embodiment, sequencer 22 may be operable to sequentially dispense a number of countermeasures over a specified time period. In another embodiment, sequencer 22 is similar to a sequencer used in an ALE-47 chaff pod. The ALE-47 chaff pod is a countermeasure dispenser system (CMDS) developed by the United States Air Force. In another embodiment, cabling between sequencer 22 and aircraft 18 includes a connector (not specifically shown) that is similar to a connector used with known chaff pod dispensers, such the ALE-47 chaff pod.

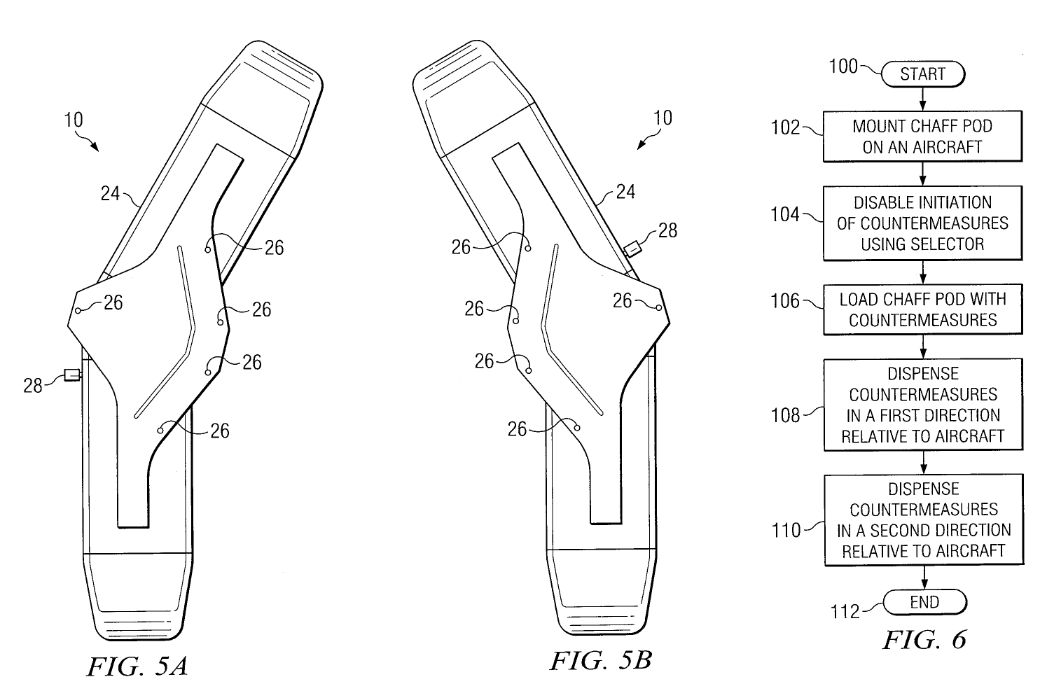

FIGS. 5A and 5B show two chaff pods 10 that may be configured on the left and right sides of the aircraft 18. Each chaff pod 10 includes a bracket 24 that may provide mounting of the chaff pod housing 12 to the aircraft 18. As shown, brackets 24 may have a number of bolt holes 26 configured in a bolt hole pattern. If the chaff pod 10 is mounted on the left side of the aircraft 18, bolt holes 26a, 26b, and 26d may be used. If the chaff pod 10 is mounted on the right side of the aircraft 18, bolt holes 26a, 26c, and 26e may be used. In one embodiment, the bolt hole pattern used in either case may be similar to a bolt hole pattern of a known chaff pod, such as the ALE-47 chaff pod. In this manner, the chaff pod 10 may be mounted to either side of the aircraft 18 using existing bolt holes in the aircraft 18. Thus, the bracket 24 may provide a retrofit for mounting chaff pod to an aircraft 18 that has been originally designed for use with an ALE-47 chaff pod.

In one embodiment, chaff pod 10 may include a selector 28 that is physically adjustable by a user to alternatively enable or disable operation of the chaff pod 10. For example, while servicing the aircraft 18, the selector 28 may be manipulated to disable operation of the chaff pod 10 such that the countermeasures stored in dispensers 14a and 14b may not be inadvertently dispensed. In this manner, users may be protected from possible injury due to unwanted activation of countermeasures.

Modifications, additions, or omissions may be made to chaff pod 10 without departing from the scope of the disclosure. The components of chaff pod 10 may be integrated or separated. For example, chaff pod housing 12 may be formed of a single piece of material, or may comprise two or more independently formed pieces that are coupled together using fasteners, such as bolts or adhesives. Moreover, the operations of chaff pod 10 may be performed by more, fewer, or other components. For example, sequencer 22 may include additional circuitry that may be used for other functions, such as thermal control of countermeasures housed in chaff pod housing 12. Additionally, operations of sequencer 22 may be performed using any suitable logic comprising software, hardware, and/or other logic. As used in this document, “each” refers to each member of a set or each member of a subset of a set.

FIG. 6 is a flowchart showing one embodiment of a series of actions that may be performed to implement chaff pod 10 on an aircraft 18 according to the teachings of the present disclosure. In act 100, the process is initiated.

In act 102, chaff pod 10 is mounted on an aircraft 18. Aircraft 18 may be any suitable type of aircraft that may benefit from use of countermeasures, such as a military airplane or a military helicopter. In one embodiment, chaff pod 10 comprises a bracket 24 with a bolt hole pattern 26 that allows mounting on the left side or the right side of aircraft 18. In another embodiment, bracket 24 includes a bolt hole pattern 26 similar to that of an ALE-47 chaff pod.

In act 104, initiation of countermeasures may be disabled using selector 28. Selector 28 may be any manually actuated mechanism, such as a switch, that selectively enables or inhibits operation of countermeasures configured in chaff pod 10. In some embodiments, selector 28 may provide enhanced safety for personnel who service or install countermeasures in chaff pod 10. When service or installation of countermeasures is completed, initiation of countermeasures may be allowed using selector 28.

In act 106, countermeasures are loaded into two dispensers 14a and 14b of chaff pod 10. Any suitable type of countermeasures may be used, such as flares or chaff.

In act 108, one or more first countermeasures are dispensed in a first direction relative to the orientation of aircraft 18. Countermeasures may be dispensed in any suitable manner. In one embodiment, countermeasures are dispensed by a sequencer 22 that initiates countermeasures in response to a command from aircraft 18.

In act 110, one or more second countermeasures may be dispensed in another direction relative to the orientation of the aircraft 18 that is different from the direction in which the first countermeasures were dispensed. In one embodiment, the second countermeasures are dispensed at an angle relative to the first countermeasures that is approximately 120 to 170 degrees apart. In another embodiment, the first countermeasures may be dispensed outwardly from a side of aircraft and the second countermeasures may be dispensed outwardly from a front of aircraft 18.

Acts 108 and 110 may be repeatedly performed till some or all countermeasures are dispensed from chaff pod 10. In act 112, the process ends.

Modifications, additions, or omissions may be made to the method without departing from the scope of the disclosure. The method may include more, fewer, or other acts. For example, sequencer 22 may include a technique that provide simultaneous initiation of multiple countermeasures from the same dispenser 14a or 14b or from differing dispensers 14a or 14b. As another example, procedures for installation and maintenance of chaff pod 10 may include other actions, such as routine cleaning and/or various verification procedures to verify proper operation of chaff pod 10.

Although several embodiments have been illustrated and described in detail, it will be recognized that substitutions and alterations are possible without departing from the spirit and scope of the present invention, as defined by the following claims.

What is claimed is:

1. A chaff pod comprising:
a first dispenser having a first surface defining a first opening through which a first plurality of countermeasures are dispensed;
a second dispenser having a second surface defining a second opening through which a second plurality of countermeasures are dispensed; and
a chaff pod housing configured to removably couple the first dispenser and the second dispenser to an aircraft, the chaff pod housing comprising:
a bracket having a bolt hole pattern configured to allow mounting of the chaff pod on a first side or a second side of the aircraft;
the first dispenser and the second dispenser coupled to the chaff pod housing, the first dispenser directing the first plurality of countermeasures outwardly from a side of the aircraft, the second dispenser directing the second plurality of countermeasures outwardly from a front of the aircraft, a difference between the first direction and the second direction being in the range of 120 to 170 degrees.

2. The chaff pod of claim 1, wherein the first plurality of countermeasures and the second plurality of countermeasures comprises a plurality of chaff or a plurality of flares.

3. A chaff pod comprising:
a first dispenser having a first surface defining a first opening through which a first plurality of countermeasures are dispensed;
a second dispenser having a second surface defining a second opening through which a second plurality of countermeasures are dispensed; and
a chaff pod housing configured to couple the first dispenser and the second dispenser to an aircraft, the first dispenser and the second dispenser coupled to the chaff pod housing, the first dispenser directing the first plurality of countermeasures in a first direction, the second dispenser directing the second plurality of countermeasures in a second direction, a relative angle being the difference between the first direction and the second direction.

4. The chaff pod of claim 3, wherein the first direction is substantially normal to a side of the aircraft and the second direction is substantially normal to a front of the aircraft.

5. The chaff pod of claim 3, wherein the first plurality of countermeasures and the second plurality of countermeasures comprises a plurality of chaff or a plurality of flares.

6. The chaff pod of claim 3, further comprising a sequencer coupled to the first dispenser and the second dispenser, the sequencer configured to initiate dispersal of the first plurality of countermeasures and the second plurality of countermeasures in response to a command.

7. The chaff pod of claim 3, wherein the relative angle is in the range of 120 to 170 degrees.

8. The chaff pod of claim 3, wherein the chaff pod housing comprises a bracket having a bolt hole pattern configured to allow mounting of the chaff pod on a first side or a second side of the aircraft.

9. The chaff pod of claim 3, further comprising a selector coupled to the chaff pod housing, the selector configured to selectively disable at least one of the first dispenser and the second dispenser.

10. The chaff pod of claim 3, wherein the aircraft is a military helicopter.

11. A method for dispensing countermeasures comprising:
dispensing one or more first countermeasures in a first direction, the one or more first countermeasures dispensed by a first dispenser that is housed in a chaff pod housing, the chaff pod housing coupled to an aircraft; and
dispensing one or more second countermeasures in a second direction that is different from the first direction, the one or more second countermeasures dispensed by a second dispenser that is housed in the chaff pod housing.

12. The method of claim 11, wherein:
the first direction is substantially normal to a side of the aircraft; and
the second direction is substantially normal to a front of the aircraft.

13. The method of claim 11, wherein the one or more first countermeasures and the one or more second countermeasures comprises one or more chaff or one or more flares.

14. The method of claim 11, further comprising initiating dispersal, by a sequencer, of the one or more first countermeasures and the one or more second countermeasures in response to a command.

15. The method of claim 11, wherein the first direction and second direction differs by an angle that is in the range of 120 to 170 degrees.

16. The method of claim 11, further comprises:
mounting the chaff pod housing on a first side of the aircraft using a bracket having a bolt hole pattern; and
mounting the chaff pod housing on a second side of the aircraft using the bracket.

17. The method of claim 11, further comprising selectively disabling at least one of the first dispenser and the second dispenser using a selector.

18. The method of claim 11, wherein the aircraft is a military helicopter.
